(19) United States
(12) Patent Application Publication
(10) Pub. No.: US 2003/0147562 A1
(43) Pub. Date: Aug. 7, 2003

(54) Method and device for identifying and/or correcting defects during digital image processing

(76) Inventors: Tobias Damm, Muenchen (DE); Thomas Schuhrke, Muenchen (DE); Gudrun Taresch, Muenchen (DE)

Correspondence Address: Karl F Milde Jr, Milde & Hoffberg, Suite 460, 10 Bank Street, White Plains, NY, 10606, US

(21) Appl. No.: 10/311,164

(22) PCT Filed: May 17, 2001
(86) PCT No.: PCT/EP01/05650

(30) Foreign Application Priority Data
Jun. 16, 2000 (DE) 100 29 826.5

(51) Int. Cl. G06K 9/40

(52) U.S. Cl. 382/275

(57) ABSTRACT

The invention relates to a method and device for identifying and/or correcting defects during digital image processing. Said device comprises a device for routing energy of a light source to a storage medium in the visible range of the electromagnetic spectrum, and comprises a device for generating a multitude of visible images by determining the energy from the storage medium. According to the invention, a visible image is additionally generated in the at least low color sensitivity range of the storage medium, which identifies defects and/or fluctuations in brightness during image recording. The additional visible image can be used for correcting defects of the multitude of visible images.

The invention is based on a method and a device for identifying and/or correcting defects during digital image processing as set forth in the main subject of claims 1, 4 or 14, respectively.

To correct defects caused by scratches or dust in films or scanned images an infrared scan is performed in addition to the typical red, green and blue scans according to U.S. Pat. No. 5,266,805. At the defect location, the infrared radiation cannot freely penetrate the film and is dispersed resulting in reduced infrared radiation penetrating the film location with the scratches or dust. This reduction is then an indication for an error in the image and the corresponding pixel is marked accordingly, such that it can be corrected subsequently. Essentially, there are two known options for correction. One option is to compute the red, green and blue signal (RGB signal) of the entire image together with the IR signal. This method is used in particular for correcting light defects where residual RGB information can be obtained and used for the correction. This method is very efficient because the scans can be computed with each other as a whole without the need to consider each individual pixel. However, with very severe defects, where no residual image information is present, this method can lead to erroneous results. The second option for error correction lends itself to such situations. This method is based on recognizing the erroneous pixels and replacing their image values with the image values of adjacent pixels. It can be expected that this interpolation method brings very good results for severe defects in very uniform areas. However, the latter method is very elaborate because individual pixels need to be stored and processed.

However, for the known defect identification during digital image processing, it should be noted fundamentally that infrared-corrected and thus cost-intensive optics are required for the additionally necessary IR scans. In addition, it is critical to handle the infrared radiation appropriately as heat radiation because it leads to a heating up of, for example, absorption filters or other optical components and needs to be removed through cooling or other measures.

It is the objective of the present invention to provide a method and a device for identifying defects for digital image processing such that a high-quality defect identification can be achieved with a simple and cost-effective design.

This objective is accomplished with a method and a device with the combination of features according to claims 1, 4 or 14, respectively. According to the invention, an additional visible image (a defect image) is generated in the at least low spectral density range of the storage medium, which identifies defects and/or fluctuations in brightness during image recording. In other words, compared to the state-of-the-art, an IR scan is avoided or replaced by an additional optical scan. In this manner, no additional cost-intensive optics is required for the method and device subject to the invention; instead conventional, cost-effective optics designed for the visible range can be relied upon. At the same time, the identification and correction of the error locations is more accurate, because the light used with this method and this device for the detection and correction exhibits the same spectral characteristics as the light used for acquiring the image data, while the infrared light exhibits different dispersion properties.

To enable a combination of the defect images with the visible images or an interpolation of the defective locations in the image, the defect locations are preferably localized in the storage medium and/or particles on the storage medium and then stored. Thereafter, the localized defects can be corrected using interpolation of values surrounding the defective pixel or by replacing the defective image location with a uniform color image information of a similar image (e.g., in video films).

Alternatively, the fluctuations in brightness of the storage medium that may be caused by defects or particles, for example, and/or fluctuations in brightness of the optics in use (e.g., drop at the edges of lenses) and/or of the recording medium in use (e.g., defective pixels of the CCD) can be compensated directly through the interaction of the multitude of visible images with the additional visible image.

With conventional films, it has turned out to be advantageous to generate the additional visible image in a wavelength range between about 580 and 630 nm, preferably between 590 and 610 nm, because in general the minimum of the spectral density of the films occurs here in the optical spectral range, and the density of the film mask is low. Alternatively, the visible image can be generated with at least low spectral density in a wavelength range between about 480 and 530 nm. It is also advantageous to record the additional visible image in a wavelength range between about 390 and 430 nm or 740 and 780, because there is no overlapping of two colors in these ranges.

According to an advantageous exemplary embodiment of the present invention, the conducting of the energy from the light source to the storage medium includes the conducting in any sequence of the red, green and blue light into the storage medium and the subsequent determination of a corresponding red, green and blue image from the storage medium. In this manner, the methods and the device subject to the invention can be employed in popular image processing or even retrofitted in existing image processing with little effort.

To simplify the design of the device subject to the invention, the energy of the multitude of visible images and of the additional image is guided across the same optical path. However, to reduce the image processing time, the energy of the multitude of visible images and of the additional visible image can also be guided across separate optical paths. Although this will lead to a more complex device, it serves, as has been mentioned, a faster image processing speed.

A film is preferably used as the storage medium. The film may contain image information that is stored as a color image. At the same time, the storage medium may be largely reflective. Alternatively, the storage medium may also be a print.

Finally, with the method or device subject to the invention, a corrective process can, of course, be performed at the identified defect locations and/or fluctuations in brightness. In particular the two correction methods mentioned initially lend themselves to this purpose.

Additional details and advantages will become apparent from the description of exemplary embodiments based on the drawings, of which

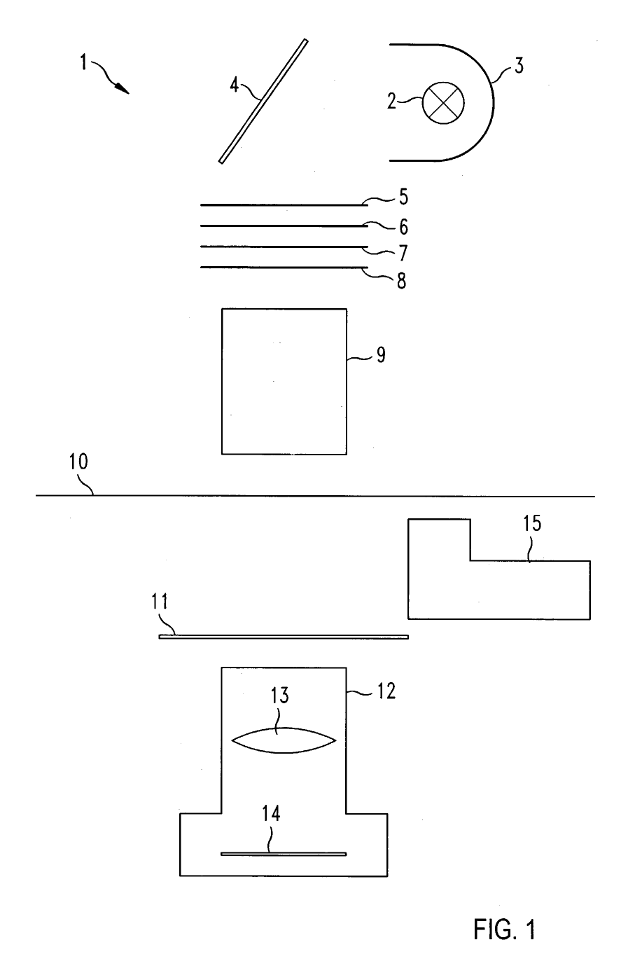

FIG. 1 is a schematic presentation of a first exemplary embodiment of a device subject to the invention,

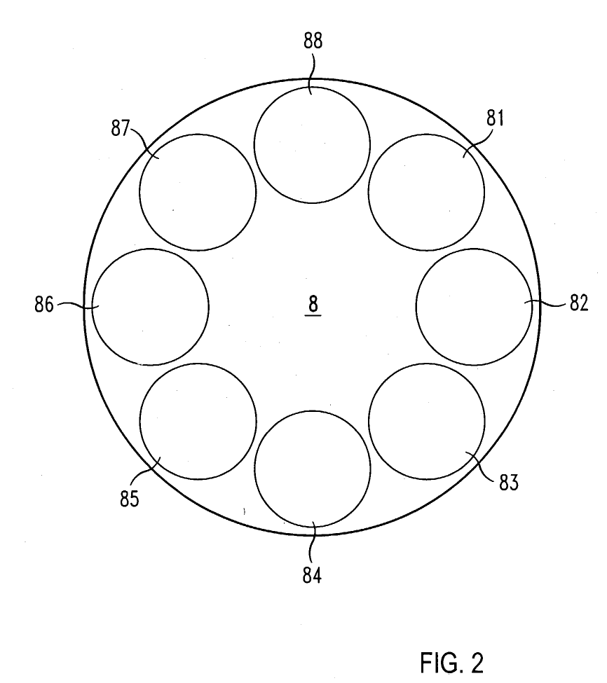

FIG. 2 is a schematic presentation of a filter wheel for the first exemplary embodiment subject to the invention,

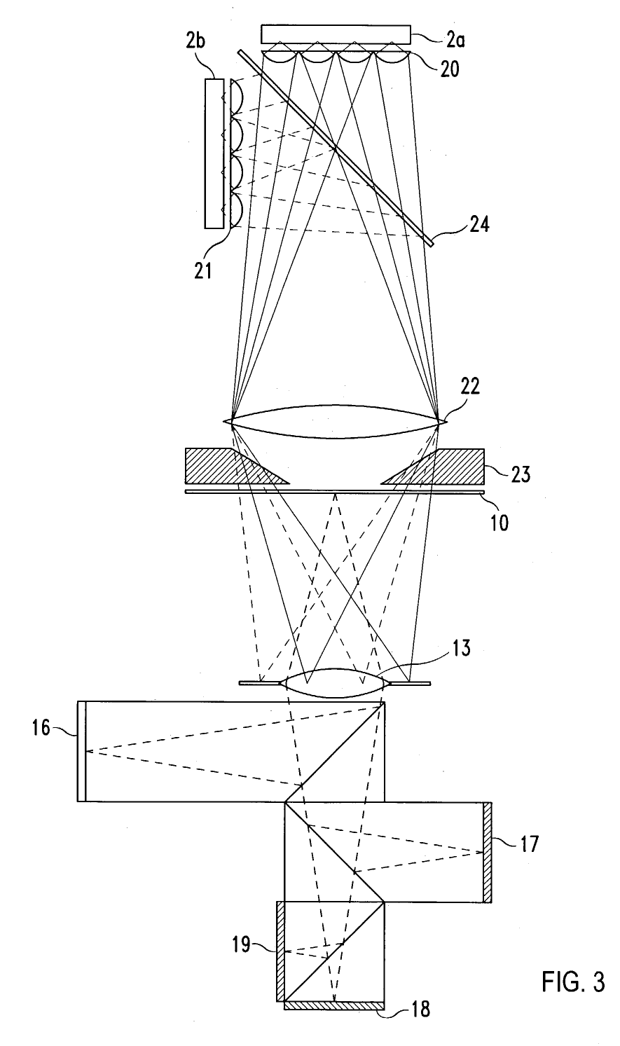

FIG. 3 is a schematic presentation of a second exemplary embodiment of a device subject to the invention, and

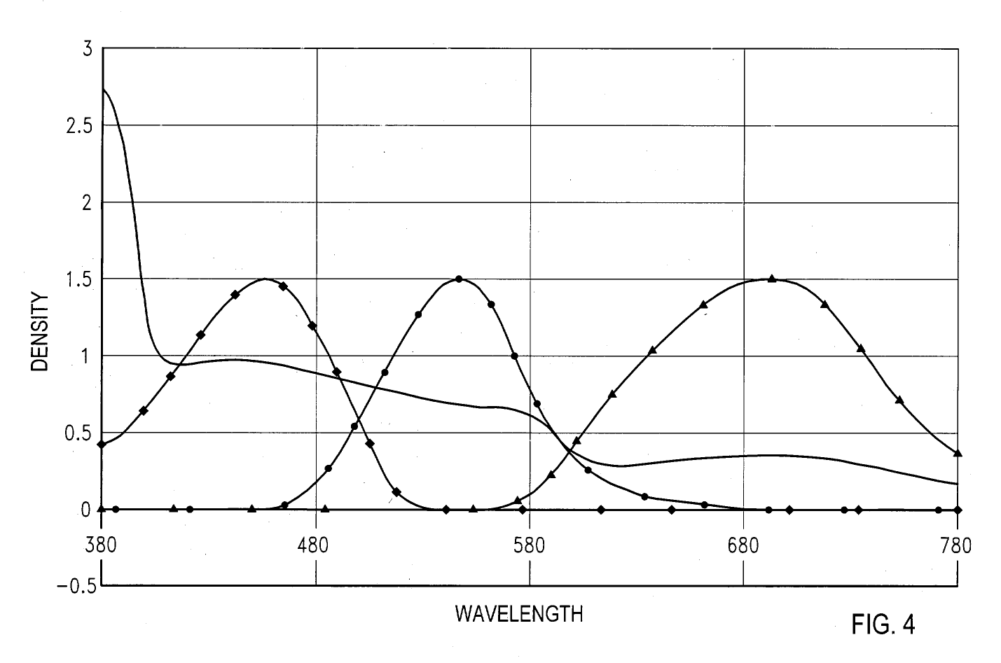

FIG. 4 shows the spectral density curves of a film corresponding to different light wavelengths.

FIG. 1 shows the schematic design of a first exemplary embodiment of the device subject to the invention for the identification and/or correction of defects during digital image processing. The device 1 subject to the invention includes a lamp 2, in particular a halogen lamp that is partially surrounded by a reflector 3 that deflects the light emitted by the lamp 2 to a mirror 4, in particular a cold light mirror. The cold light mirror 4 deflects the light from the reflector 3 and originating directly from the lamp 2 to a filter paddle 5. The light passes through the filter paddle 5 and thereafter through a light attenuator 6, a shutter 7 as well as a filter wheel 8. The filter wheel 8 includes color filters for both negatives and slides. As FIG. 2 shows, red, green and blue filters (81, 82, 83) are provided for negatives as well as red, green and blue filters (85, 86, 87) for slides and additional filters (84, 88) for the additional scan for both negatives and slides. It is possible to omit the filters for the slide scans and to scan the slides using the filters 81 to 84 intended for the negatives. The additional filters (84, 88) are transparent for the light of the specified, advantageous wavelength ranges (e.g., 590 to 610 nm—that is, for yellow light).

It is also possible to forego the filter wheel and employ a TFA (Thin Film on ASIC) detector in place of the CCD array 14 (see publication Sommer, M. et al “First Multispectral Diode Color Imager With Three Color Recognition And Color Memory In Each Pixel”, 1999 IEEE Workshop on CCDs and Advanced Image Sensors, Nagano, Japan). Using said TFA detector, the filter spectrum could be set to both the color density maximums and to a film-type-dependent density minimum that is advantageously used for identifying the defect signal.

According to the radiation path, the filter wheel 8 of FIG. 1 is followed by a mirror duct 9, from which the light that passes through said duct strikes a film 10 and passes through said film 10. The light that has now passed through the film 10 passes through a dust shutter/light attenuator 11 in the form of an NG glass and finally enters a sealed unit 12 consisting of a lens 13 and a CCD array 14.

A so-called prescanner 15 used for prescanning or prerun scanning is located between the film 10 and the light attenuator 11. The purpose for prescanning is to obtain early information about the density of the film 10 that contains the object for which the image input is to be carried out. The optimum illumination of the image plane is selected based on the information obtained in this manner. In addition, the prescanner 15 can also be used to measure film density data, etc. in a generally known manner.

FIG. 3 shows schematically the light beam path of a second exemplary embodiment of the device subject to the invention from the emission from the lamp 2 to the incidence at the CCD array 14. The CCD array 14 consists of four CCD chips 16 to 19, as will be described later. In addition, LEDs are used in place of the conventional lamp, whereby, as shown in FIG. 3 for example, the horizontal LED arrangement 2a generates the blue and the green light and the vertical LED arrangement 2b the red light and the additional light, in particular the yellow light. In place of LEDs that emit yellow light, other LEDs may be used that emit light in a wavelength range from 480 to 530 nm, 390 to 430 nm or 740 to 780 nm, as has already been explained for the color filters of the first exemplary embodiment.

The light emitting from the LEDs 2a, 2b passes through a lens arrangement 20 or 21, is partially diverted by a dichroitic beam splitter 24 and strikes the condenser lens 22. The condenser lens focuses the incident light onto the lens 13 with the imaging objective, whereby the light passes through the film 10 prior to striking the lens 13. The generally known film stage is located above said film 10. The light passes through the lens 13 and is split according to the spectral colors relevant for film processing, principally red, green, blue and yellow—or a respective other color for identifying the defect signal—and the respective spectral line portions are diverted to each assigned CCD chip 16 to 19. In FIG. 3, the yellow light that generates the additional visible image is diverted to the CCD chip 16, and the red, green and blue light to the CCD chips 17 to 19 in that order.

In this manner, the red, green and blue signals of the assigned CCD chips are computed for the generation of the total image. If defects in the form of dust or scratches are present on the film, these defects will again be found at the generation of the total image comprised of red, green and blue signals. To identify and/or correct these defects, an additional light is used for the device subject to the invention, where according to the present invention said additional light has a wavelength between 580 and 630 nm, preferably between 590 and 610 nm, or one of the aforementioned alternative wavelength ranges. This light is used to mark the defect, i.e., light striking the “Defect CCD Chip” after passing through the film with the defect generates a defect signal that marks the exact position(s) of the defect(s) in or on the film. Or it is used for direct defect correction, that is, the image generated on the “Defect CCD Chip” is combined with the other visible images.

The defect signal contains information about defects in the storage medium, particles on the same, possibly drops in brightness—caused by the light-guiding optics or an error in the recording medium—, which for simplicity sake shall in the following be combined under the term “defects”, because all these quantities are also contained in the R, G, B signals and are to be eliminated from them. In addition, contrary to the infrared signal, the defect signal in the visible range contains a weak image signal, that is, for example for yellow light a reduced portion of the red and the green signals, and the signal resulting from the film mask. This residual image signal is superimposed over the defect signal because both the density of the film and the mask density do not go fully to zero in the range of the visible spectrum, as can be gathered from FIG. 4. A maximum exposure of the film results (for example for the film type HDC 100 plus) after the development in the color densities shown in FIG. 4 for blue ( &squ& ), green (O) and red (DELTA) as well as in the mask density (−). These curves can be slightly different for various film types.

To compute the adjusted red, green and blue values, that is, to perform a defect correction, the red, green, blue and defect densities (DR, DG, DB, DD) are determined in four recordings in the visible range. The densities of the film mask (MR, MG, MB, MD) in the respective spectral ranges are either known from the film data and stored in tables from where they are retrieved after determining the film type, or they result from recordings at the positions of the unexposed film spacings. Thus, the following equations can be set up for the corrected red, green, blue and defect values (R, G, B, D):

R=DR−MR−D

G=DG−MG−D

B=DB−MB−D

D=DD−MD−α·R−β·G.

α and β are film-dependent quantities, which can be stored in tables as well, from where they are retrieved after determining the film type. As a first approximation α and β can be viewed as equal such that the equation system may be simplified.

Thus, the defect values can be determined easily from these equations. The color values reflect the defect-corrected image, from which the position and the magnitude of the defects are derived. Data about the position and the magnitude of the defects are required in particular when the signals are reduced to zero due to severe defects. An interpolation of the image data is required in such a case, because useful solutions to the equation system are no longer possible.

A more simple equation system is the outcome of an additional advantageous exemplary embodiment, where the defect signal is recorded, for example, in a range between 390 and 430 nm. Here, the following applies for the defect signal: D=DD−MD−γ·B. However, the defect signal is not as significantly different from the color signal as when the defect signal is recorded in a range between 580 and 630 nm, such that the result is easier to determine but may not be as accurate.

In addition to defect identification in or on the film, fluctuations in brightness can be compensated directly at the scanner when using, for example, yellow light in addition to the conventional colors red, green and blue, and no proper calibrations or the like are necessary, because such fluctuations caused by the edge drop at the CCD chips, objective inaccuracies, filter inaccuracies, etc affect both the yellow signal and the red, green and blue signals, and are, therefore, eliminated by the correction. With conventional detection methods, such edge drops are compensated through calibration curves that need to be established and then taken into account at the subsequent correction procedure.

Alternative to the radiation path shown in FIG. 1, where the yellow light as well as the red, green and blue light is guided across the same optical path, the different spectral ranges may, of course, also be guided across separate optical paths. It is also conceivable to send the defect light through the optical path, i.e., the elements 13 and 20 to 24, in combination with the red and/or green and/or blue light.

In the present exemplary embodiment, a film 10 was used as the storage medium. As an alternative, the storage medium 10 may, of course, also be a print. Furthermore, the film can contain image information stored as a color image and can be largely reflective.

Additional alterations and modifications of the exemplary embodiment described above are possible without departing from the scope of the appended claims.

1. A method for identifying defects during digital image processing using the following steps: conducting the energy of a light source (2) to a storage medium (10) in the visible range of the electromagnetic spectrum and generating a multitude of visible images by determining the energy from the storage medium (10), characterized in that an additional visible image is generated in the at least low density range of the storage medium (10), which identifies defects and/or fluctuations in brightness during image recording.

2. A method as set forth in claim 1, characterized in that the defect locations in the storage medium (10) and/or the particles on the storage medium (10) are being marked.

3. A method as set forth in claim 1 or 2, characterized in that a correction method is carried out at the identified defect locations and/or fluctuations in brightness.

4. A method for correcting defects during digital image processing using the following steps: Conducting the energy of a light source (2) to a storage medium (10) in the visible range of the electromagnetic spectrum and generating a multitude of visible images by determining the energy from the storage medium (10), characterized in that an additional visible image is generated in the at least low density range of the storage medium (10), which contains defects and/or fluctuations in brightness during image recording, and correcting of the visible image by combining it with the additional visible image.

5. A method as set forth in claim 4, characterized in that fluctuations in brightness are compensated based on defects in the storage medium (10) or particles on the storage medium (10).

6. A method as set forth in claim 5, characterized in that the correction method comprises an interpolation.

7. A method as set forth in claim 4, characterized in that fluctuations in brightness of a device (4 to 9, 11, 13) used for conducting the energy of a light source (2) and/or of an image generation device (12) are compensated.

8. A method as set forth in one of the claims 1 to 7, characterized in that the additional visible image is generated in a wavelength range between 580 and 630 nm, preferably between 590 and 610.

9. A method as set forth in one of the claims 1 to 7, characterized in that the additional visible image is generated in a wavelength range between 480 and 530 nm.

10. A method as set forth in one of the claims 1 to 7, characterized in that the additional visible image is generated in a wavelength range between 390 and 430 or 740 and 780 nm.

11. A method as set forth in one of the claims 1 to 10, characterized in that the energy of the multitude of visible images and of the additional visible image is conducted across the same optical path.

12. A method as set forth in one of the claims 1 to 10, characterized in that the energies of the multitude of visible images and of the additional visible image are conducted across separate optical paths.

13. A method as set forth in one of the claims 1 to 12, characterized in that preferably a film is used as a storage medium (10).

14. A device for identifying defects during digital image processing with a device (4 to 9) for conducting the energy of a light source (2) to a storage medium (10) in the visible range of the electromagnetic spectrum and with a device (12) for generating a multitude of visible images by determining the energy from the storage medium (10), characterized in that a device (16, 84, 88) for generating an additional visible image in the at least low color sensitivity range of the storage medium (10) is provided, whereby the additional visible image contains defects and/or fluctuations in brightness during the recording of the image.

15. A device as set forth in claim 14, characterized in that a color filter (84 and/or 88) is provided as the device for generating an additional visible image.

16. A device as set forth in claim 15, characterized in that the color filter is a yellow filter.

17. A device as set forth in claim 15, characterized in that the color filter is transparent in a range between 580 and 630 nm, preferably between 590 and 610 nm.

18. A device as set forth in claim 15, characterized in that the color filter is transparent in a range between 480 and 530 nm.

19. A device as set forth in claim 15, characterized in that the color filter is transparent in a range between 390 and 430 or 740 and 780 nm.

20. A device as set forth in one of the claims 14 to 19, characterized in that the device (4 to 9) conducts the energy of the multitude of visible images and of the additional visible image across the same optical path.

21. A device as set forth in claim 14, characterized in that the device for generating an additional visible image includes a sensor (16).

22. A device as set forth in claim 21, characterized in that the device for generating an additional visible image includes a beam splitter.

23. A device as set forth in claim 21 or 22, characterized in that the device (4 to 9) conducts the energy of the multitude of visible images and of the additional visible image across separate optical paths.

24. A device as set forth in one of the claims 14 or 20 to 23, characterized in that the light source (2) includes LEDs.

25. A device as set forth in claim 24, characterized in that the light source (2) includes LEDs that emit in a range between 580 and 630 nm, preferably between 590 and 610 nm.

26. A device as set forth in one of the claims 14 to 25, characterized in that the storage medium (10) is a film.
